(19) United States
(12) Patent Application Publication
(10) Pub. No.: US 2021/0192524 A1
(43) Pub. Date: Jun. 24, 2021

(54) Feature-Based Recurrent Neural Networks for Fraud Detection

(71) Applicant: PayPal, Inc., San Jose, CA (US)

(72) Inventors: Moein Saleh, Campbell, CA (US); Xing Ji, San Jose, CA (US); Chiara Poletti, Santa Clara, CA (US); Hanlin Wu, Union City, CA (US)

(73) Assignee: PayPal, Inc.

(21) Appl. No.: 16/723,746

(22) Filed: Dec. 20, 2019

(51) Int. Cl. G06Q 20/40; G06N 3/04

(52) U.S. Cl. CPC G06Q 20/4016; G06N 3/049

(57) ABSTRACT

A system performs operations that include receiving a request to process a current payment transaction between a payment provider and a user having a user account with the payment provider. The operations further include determining a state of a recurrent neural network (RNN) fraud model for the user account by accessing a cache storing a set of encoded states for a plurality of nodes included in the RNN fraud model. The RNN fraud model is executed based on data associated with the current payment transaction and the set of encoded states stored in the cache. A new set of encoded states for the plurality of nodes are encoded and stored in place of the set of encoded state previous stored in the cache.

### BACKGROUND

### Technical Field

This disclosure relates generally to fraud detection and, more specifically, to using feature-based recurrent neural networks for fraud detection.

### Description of the Related Art

Neural networks are fast becoming prevalent in the field of machine learning and/or deep learning. Two popular types of neural networks include the feed-forward neural network and the recurrent neural network (RNN). RNNs can be useful for modeling sequential data since they exhibit memory of past data via a feedback loop in their hidden layer.

Both feed-forward neural network and RNNs can be useful for modeling potential fraud with respect to digital transactions. In typical implementations, a feed-forward neural network being executed to predict fraud with respect to a current transaction uses one or more machine learning features extracted from the current transaction as input. Based on those features, the feed-forward neural network determines a likelihood that the current transaction is fraudulent. Typically, the features used by the feed-forward neural network a derived via feature engineering by those knowledgeable about the data used and produced by these transactions. However, a feed-forward neural network uses only information pertaining to the current transaction as input to determine its output.

On the other hand, an RNN is typically trained using raw data from previous transactions. The RNN maintains a state that is calculated based on previous states of the RNN. In this manner, the RNN includes a “memory” of past transactions, and this memory has a direct effect on current predictions of the RNN. This characteristic may allow the RNN to be suitable for processing sequential data. However, RNNs typically do not use engineered features and depending on implementation, RNNs can consume a relatively large amount of computing and storage resources.

### BRIEF DESCRIPTION OF THE DRAWINGS

FIG. 1 is a block diagram illustrating an example system for feature-based recurrent neural networks for fraud detection, according to some embodiments.

FIG. 2 is a diagram illustrating a data flow for feature-based recurrent neural networks for fraud detection, according to some embodiments.

FIG. 3A is a high-level diagram illustrating a recurrent neural network fraud model, according to some embodiments.

FIG. 3B is a diagram illustrating a more detailed view of the recurrent neural network fraud model of FIG. 3A, according to some embodiments.

FIG. 3C is a diagram illustrating example weights for the nodes of the recurrent neural network fraud model of FIG. 3B

FIG. 3D is a diagram illustrating new weights for the nodes after using the recurrent neural network fraud model of FIG. 3C to process a transaction.

FIG. 4 is a diagram illustrating a cache storing weights for one or more nodes of a recurrent neural network fraud model, according to some embodiments.

FIG. 5 illustrates a flow diagram illustrating a method for feature-based recurrent neural networks for fraud detection, according to some embodiments.

FIG. 6 is a block diagram illustrating an exemplary computing device, according to some embodiments.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “model processing module” “configured to run and/or execute the RNN fraud model” is intended to cover, for example, a device that performs this function during operation, even if the corresponding device is not currently being used (e.g., when its battery is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed mobile computing device, for example, would not be considered to be “configured to” perform some specific function, although it may be “configurable to” perform that function. After appropriate programming, the mobile computing device may then be configured to perform that function.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor and is used to determine A or affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the term “processing element” refers to various elements configured to execute program instructions (or portions thereof or combinations thereof). Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof.

### DETAILED DESCRIPTION

Techniques are disclosed for an algorithm for feature-based recurrent neural networks for fraud detection. A service provider system maintained by a service provider is configured to process digital transactions between the service provider and a user have a user account with the service provider. As part of processing a transaction, the service provider system is configured to run and/or execute a recurrent neural network (RNN) model to determine a risk level associated with the transaction. The risk level indicates a likelihood that the transaction is a fraudulent transaction.

The service provider system implements the RNN fraud model by first training the RNN fraud model. To this end, the service provider system is configured to select a set of features that were previously generated (e.g., by the service provider system itself and/or another device) based on information association with multiple transactions of various user accounts with the service provider. In certain instances, such features may have been previously computed via feature engineering by an engineer or may be automatically generated via various feature engineering techniques. The service provider system is configured to extract feature values from applying the selected set of features to a set of training data. The extracted feature values are input into the RNN fraud model iteratively until a desired performance threshold for the RNN fraud model is reached.

The RNN fraud model includes one or more nodes in an input layer, one or more nodes in a hidden layer, and one or more nodes in an output layer. Each of the nodes in the hidden layer is associated with a respective hidden state that is updated with each execution of the RNN fraud model. In particular, the hidden states for the nodes in the hidden layer can change (or remain the same) as a result of processing each new set of inputs for nodes in the input layer. The hidden state for each of the nodes in the hidden layer of the RNN fraud model therefore collectively represent the state of the RNN fraud model. To this end, a current state of the RNN fraud model (i.e., one or more of the hidden states) are stored in a cache, and the contents of the cache are updated during execution of the RNN fraud model.

Furthermore, each user account may be associated with a respective set of hidden states that are generated based on past transactions of the user account with the service provider. As a result, the respective set of hidden states for each user account may be different from each other based on different transaction histories for each user account. Additionally, each user account may be allocated a respective storage space within the cache to store the respective set of hidden states. According to a particular embodiment, the stored hidden states for a particular user account are replaced with new hidden states each time the RNN fraud model is run for the user account (e.g., to process a transaction).

For example, at run-time (e.g., production), when the transaction for the user account is processed, the service provider system determines current feature values based on applying the selected set of features to transaction information associated with the transaction. For instance, the transaction information may include, but is not limited to, network information (e.g., Internet Protocol address, ports, or other networking data), geographic location information (e.g., Global Position Satellite information), user identifiers (e.g., customer identifiers, merchant identifiers, etc.), transaction identifiers, payment amounts, and/or the like. Using this example, current feature values may include, but are not limited to, number of transactions by the user for the past number days, number of transactions for a merchant, number of bad transactions for the merchant, and/or the like.

The current feature values are input into the RNN fraud model, and the service provider system retrieves the hidden states that are stored in the cache. Based on the current feature values and the retrieved hidden states, the RNN fraud model calculates one or more outputs, such as a risk score for the current transaction. Further, the current feature values may also cause one or more of the retrieved hidden states of the nodes to change values. The new hidden states are stored in the cache and replace the previously stored hidden states that were used to calculate the output(s) of the RNN fraud model for the current transaction.

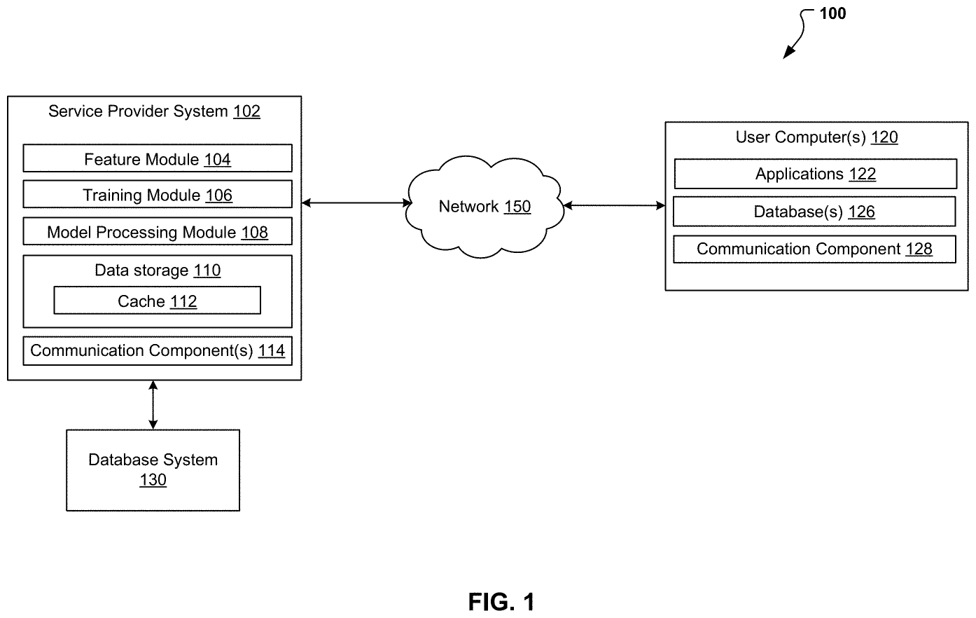

FIG. 1 is a block diagram illustrating an example system 100 for feature-based recurrent neural networks for fraud detection. In the illustrated embodiment, the system 100 includes a service provider system 102, maintained by a service provider, in communication with other computer(s) 120 via a network 150. The service provider system 102 is also in communication with a database system 130. It will be appreciated that while FIG. 1 depicts database system 130 as separate from the service provider system 102, in other embodiments, the database system may be included in the service provider system 102.

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

In FIG. 1, service provider system 102 may include a feature module 104, a training module 106, a model processing module 108, a data storage 110 that include a cache 112, and communication components 114. Each of the components of the service provider system 102 may communicate with each other to managing stale connections in a distributed system, as will be described in more detail below.

The feature module 104 is configured to generate one or more features derived from transaction information associated with past transactions, from various user accounts with the service provider, that have been processed by the service provider system 102. As used herein, “features” generated by the feature module 104 and/or used by any of the components of the system provider system 102 may refer to machine learning features that are derived from a dataset to improve the predictive abilities of a model during training. According to a particular embodiment, the feature module 104 is configured to perform automated feature engineering with respect to the transaction information to automatically generate features. In other embodiments, the feature module 104 is a tool used by a feature engineer to derive one or more features based on the transaction information. The features generated by the feature module 104 may be stored in a database system 130.

The training module 106 is configured to train an RNN fraud model using one or more of the features generated by the feature module 104. A particular set of features from those generated by the feature module 104 may be selected for training the RNN fraud model. As such, the training module 106 may access the database system 130 (and/or any other storage device storing the features) to retrieve the selected set of features. The training module 106 may also access and/or be otherwise provided with sample transaction information. The sample transaction information represents transactions whose outcome with respect to a decisioning being modeled is already known. In this case, the decisioning may be a risk level (e.g., a risk score) for each transaction in the sample transaction information. The training module 106 is configured to train the RNN fraud model using the selected set of features and the sample transaction information by measuring the outputs of the RNN fraud model against the expected outputs included in the sample transaction information.

During training one or more weights may be calculated with respect to the RNN fraud model. For instance, the RNN fraud model includes an input layer having a set of input nodes, a hidden layer including a set of hidden nodes, and an output layer including a set of output nodes. Connections between the nodes may be assigned different weights during training, and the weights may be continuously adjusted until training is completed. Further, each hidden node in the hidden layer may include a respective hidden state. Each hidden state for each hidden node may be a function of the input(s) to the hidden node and the previous state of the hidden node. The respective functions used to calculate the hidden states of the hidden nodes may be the same or different from each other.

According to a particular embodiment, each user account with the service provider may be associated with a respect set of hidden states to be used for running the RNN fraud model. The respective set of hidden states are stored in a cache 112. According to certain embodiments, each user account may be provided with an initial set of hidden states (stored in the cache 112) before running the RNN fraud model for the first time with respect to transactions of the user account. The initial set of hidden states may the same or may be different for each user account. Over time, however, the set of hidden states for each user account are likely to change based on different transaction information for the different transactions in which each of the user accounts participate. As such, the respective set of hidden states for each user account at a given point in time represents the state of the RNN fraud model with respect to that user account at that point int time. In this manner, the RNN fraud model includes a “memory” of past transactions for each user account and is able to account for information in those past transactions of each user account to inform predictions (e.g., risk scores) of current transactions.

The model processing module 108 is configured to run and/or execute the RNN fraud model during real-time operation of the service provider system 102. That is, when a current transaction is initiated between a user account and the service provider system 102, the model processing module 108 executes the RNN fraud model in real-time based on current transaction information associated with the current transaction. As such, the model processing module 108 may be configured to extract the selected set of features from the current transaction information. Further, the model processing module 108 retrieves a set of hidden states corresponding to the user account from the cache 112. The set of hidden states represent the current state of the RNN fraud model for the user account. In particular, the current state was calculated as part of executing the RNN fraud model for the transaction of the user account immediately preceding the current transaction.

The model processing module 108 provides the set of hidden states and the extracted set of features from the current transaction information to the RNN fraud model. Based set of hidden states and the extract set of features, the RNN fraud model generates an output (e.g., a risk score) associated with the current transaction. Based on the output (e.g., and possibly in conjunction with other outputs from other models), the service provider system 102 may determine whether the current transaction is legitimate or fraudulent. Additionally, execution of the RNN fraud model may cause one or more of the set of hidden states to be changed/adjusted, thereby resulting in a new set of hidden states for the user account. The model processing module 108 is configured to store the new set of hidden states in the cache 112, such that the set of hidden states that were previously stored in the cache 112 are replaced, and only the new set of hidden states remain in the cache 112.

Storing only one set of hidden states for a user account reduces the amount of storage required for maintaining respective set of hidden states for multiple user accounts. Such an implementation enables execution of the RNN fraud model to scale to service provider systems 102 having a large number of user accounts. It will be appreciated, however, that in other embodiments, more than one set of hidden states may be stored for each user account.

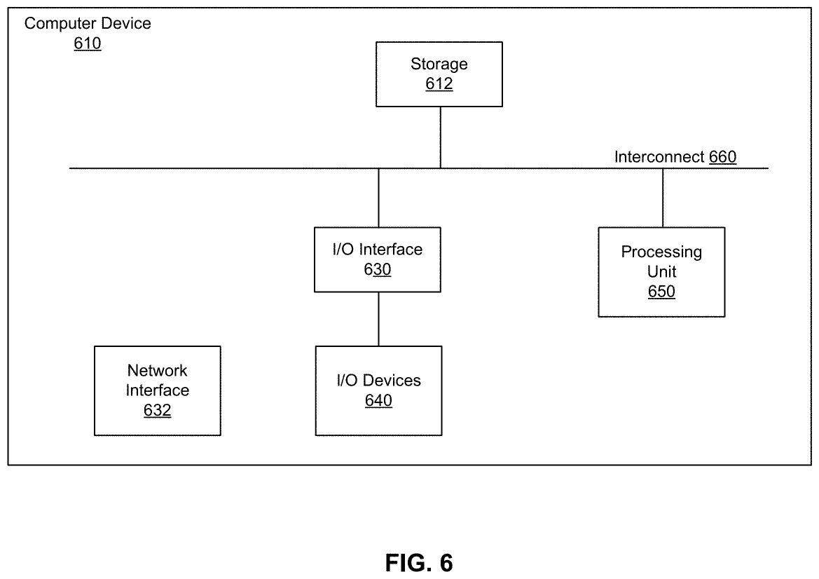

The data storage 110 stores various information that the applications 122 connect to the service provider system 102 to access. The data storage 110 may include any type of storage medium, as described in more detail with reference to the storage 612 in FIG. 6. The data storage also includes cache 112. Cache 112 may be a single cache or may include multiple different caches.

The communication component 114 may be configured to communicate with various other devices, such as the other computer(s) 120 and/or other devices. In various embodiments, communication component 14 may include a Digital Subscriber Line (DSL) modem, a Public Switched Telephone Network (PTSN) modem, an Ethernet device, a broadband device, a satellite device and/or various other types of wired and/or wireless network communication devices including microwave, radio frequency, infrared, Bluetooth, Bluetooth low-energy, near field communication (NFC) devices, and/or the like.

It will be appreciated that the database system 130 may include, for example, identifiers (IDs) such as operating system registry entries, cookies, IDs associated with hardware of the communication component 114, IDs used for payment/user/device authentication or identification, and/or other appropriate IDs. Further, the database system 130 may store login credentials (e.g., such as to login to an account with the service provider and/or other accounts with other service providers), identification information, biometric information, and/or authentication information of the user

FIG. 1 further illustrates the other computer(s) 120, each of which includes applications 122, database 126, and communication component 128. As previously discussed, the applications 122 may be any type of application that access the service provider system 102. According to a particular embodiment, the applications are user applications for a payment service provider that communicates with the service provider system 102 to facilitate payment transactions and other financial transactions.

The network 150 may be implemented as a single network or a combination of multiple networks. For example, in various embodiments, the network 150 may include the Internet or one or more intranets, landline networks, wireless networks, and/or other appropriate types of networks. Thus, the network 150 may correspond to small scale communication networks, such as a private or local area network, or a larger scale network, such as a wide area network or the Internet, accessible by the various components of system 100.

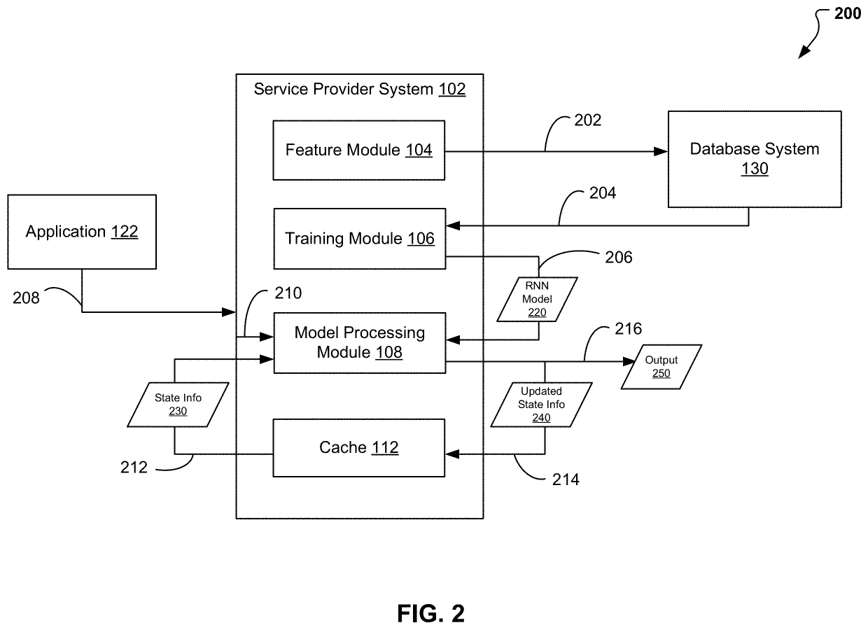

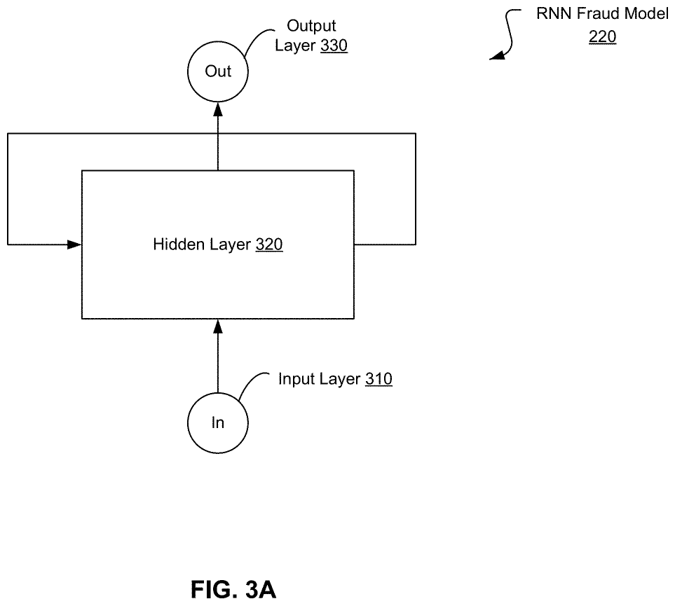

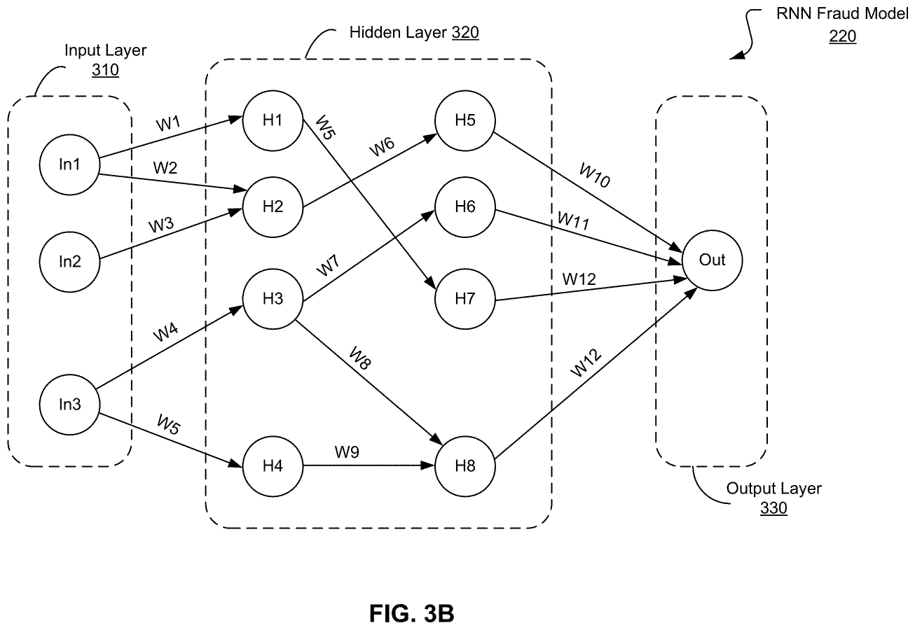

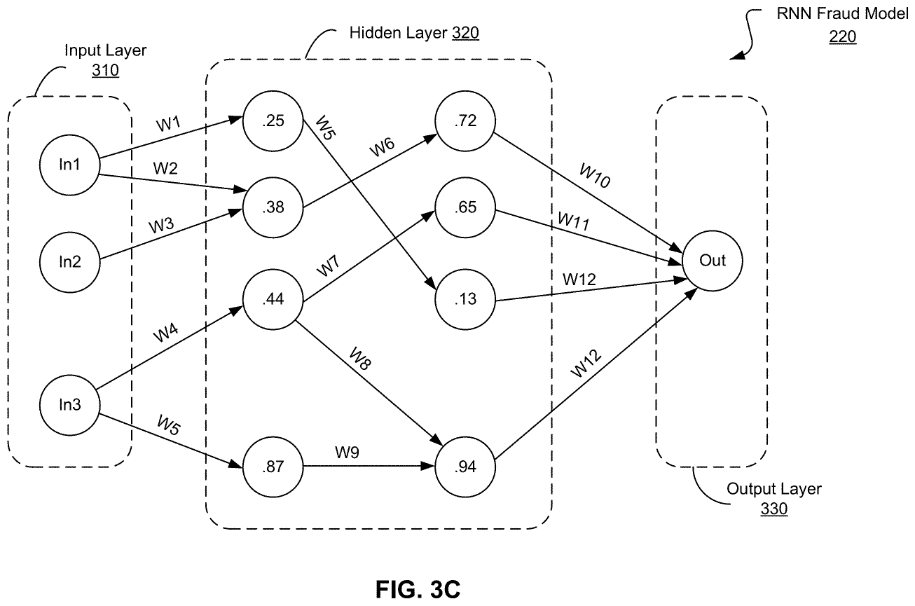

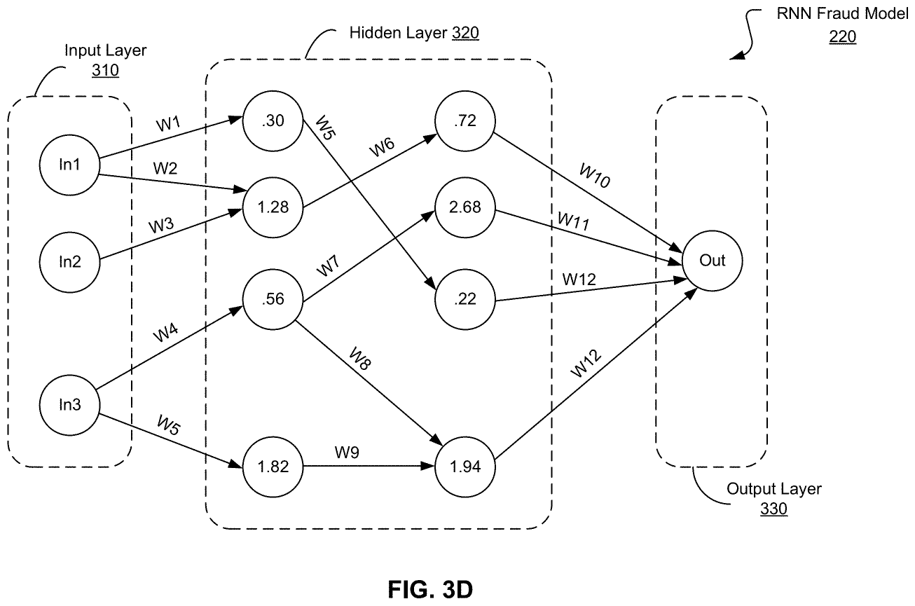

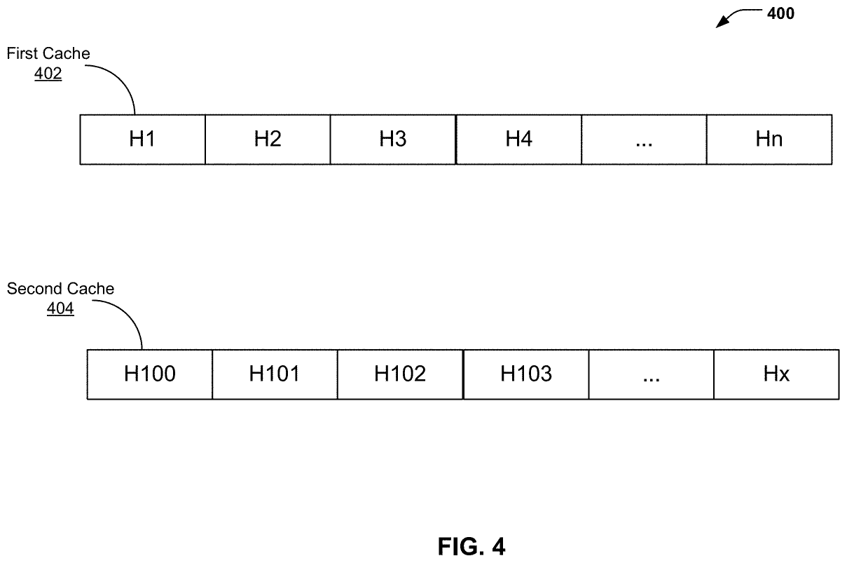

FIG. 2 illustrates a data flow diagram 200 for feature-based recurrent neural networks for fraud detection in accordance with another particular embodiment. Portions of FIG. 2 are described in conjunction with FIG. 3A-D, and FIG. 4. As shown in FIG. 2, the feature module 104 of the service provider system 102 provides one or more features to be stored in the database system 130 at step 202. As previously discussed, the feature module 104 generates multiple features based on past transaction information and that may have predictive aspects for fraud detection when implemented with a machine learning model.

At step 204, the training module 106 selects a set of features from the features provided by the feature module 104. The training module 106 retrieves the set of features from the database system 130 as well as sample transaction information. Based on the set of features and the sample transaction information, the training module 106 is configured to generate a RNN fraud model 220.

Referring now to FIG. 3A, an example diagram of RNN fraud model 220 is depicted in accordance with one or more example embodiments. As shown in FIG. 3A, the RNN fraud model 220 may include an input layer 310, a hidden layer 320, and an output layer 330. The hidden layer 320 may include a feedback loop that updates certain hidden states maintained within the hidden layer 320. The states are updated via one or more hidden state functions that are functions of the inputs received by the input layer 310 and previous hidden states. The RNN fraud model 220 also generates one or more outputs via the output layer 330 based on the inputs received by the input layer 310 and the hidden states of the hidden layer 320.

FIG. 3B illustrates a more detailed view of the RNN fraud model 220. As shown in FIG. 3B the input layer 310 includes one or more input nodes (In1-In3), the hidden layer 320 includes one or more hidden nodes (H1-H8), and the output layer 330 includes an output node. It will be appreciated that the number of nodes depicted in each layer of the RNN fraud model are merely examples, and that any number of nodes within each layer is possible.

Further, each node except for the input nodes receives, as input, an output from at least one other node. For example, the input(s) to each of nodes H1-H4 is the output from at least one of input nodes In1-In3. Similarly, each of nodes H5-H8 receives the output from at least one of nodes H1-H4, and the output node receives the output from nodes H5-H8. The inputs and outputs among the nodes in the RNN fraud model 220 form connections between the nodes. Each of these connections are associated with a weight (e.g., weights W1-W12). As such, each node generates an output which is then adjusted based on the weight(s) associated with any connection(s) to the subsequent node(s). Notably, the input nodes In1-In3, receive their input based on transaction information and not from other nodes. More specifically, the input to the input nodes (e.g., and therefore to the RNN fraud model 220) may be one or more features selected from the transaction information.

Each of the hidden nodes H1-H8 may be associated with a respective hidden state. Each hidden state may be a function of the most recent previous input(s) to its respective node and the most recent previous hidden state for that node. Thus, each new set of features from each new transaction that is processed by the RNN fraud module 220 can potentially change the hidden states of hidden nodes H1-H8. The hidden states are stored in a cache, such as cache 112.

Referring back to FIG. 2, at step 208, a user application, such as application 122 communicates with the service provider system 102 to complete a current transaction between a user account and the service provider. At step 210, the model processing module 108 extracts the set of features (e.g., the features previously selected by the training module 106 to train the RNN fraud model 220) from current transaction information associated with the current transaction. At step 212, the model processing module 108 accesses the cache 112 to retrieve state information 230 corresponding to the current hidden state of the RNN model 220.

For example, FIG. 3C illustrates the RNN fraud model 220 with example hidden states for hidden nodes H1-H8 for the user account described with reference to FIG. 2. As shown in FIG. 3C, node H1 has a hidden state of 0.25, node H2 has a hidden state of 0.38, node H3 has a hidden state of 0.44, node H4 has a hidden state of 0.87, node H5 has a hidden state of 0.72, node H6 has a hidden state of 0.65, node H7 has a hidden state of 0.13, and node H8 has a hidden state of 0.94. According to a particular embodiment, these hidden states may be stored in the cache 112 and may be included in the state information 230 retrieved by the model processing module 108.

At step 214, the model processing module 108 calculates a set of new hidden states for hidden nodes H1-H8 and stores the set of new hidden states in the cache 112 as updated state information 240. In certain implementations, the set of new hidden states replaces the previously stored hidden states (e.g., the state information 230) in the cache 112. Further, the model processing module 108 calculates the set of new hidden states as a function of the extracted features from the current transaction information and the state information 230 retrieved from the cache 112.

For example, FIG. 3D illustrates the RNN fraud model 220 that includes the updated state information 240 generated by the model processing module 108. As shown in FIG. 3D, node H1 now has a hidden state of 0.30, node H2 now has a hidden state of 1.28, node H3 now has a hidden state of 0.56, node H4 now has a hidden state of 1.82, node H5 maintains the hidden state of 0.72, node H6 now has a hidden state of 2.68, node H7 now has a hidden state of 0.22, and node H8 now has a hidden state of 1.94. Again, the updated hidden states of nodes H1-H8 are stored in the cache 112 and replaces the previous hidden states of nodes H1-H8.

Referring once again to FIG. 2, the model processing module 108 provides an output 250, at step 216, that is generated by the RNN fraud model 220. The output 250 may be a risk score calculated based on the extracted features from the current transaction information, the state information 230, the updated state information 240, other factors, and/or a combination of the above. The risk score (output 250) may indicate a likelihood that the current transaction is a fraudulent transaction. In some embodiments, if the risk score satisfies a score threshold, the service provider system 102 determines that the current transaction is likely a fraudulent transaction and terminates the current transaction. Otherwise, the service provider system 102 continues processing the transaction to completion. In other embodiments, the output 250 is one of multiple components used to determine a risk level of the transaction.

Referring now to FIG. 4, a diagram 400 is illustrated of a first cache 402 and a second cache 404 of service provider system 102. The first cache 402 may store hidden state information H1-Hn for a first user account for RNN fraud model 220. The second cache 404 may store hidden state information H100-Hx for a second user account for the RNN fraud model 220. Hidden state information H1-Hn may be different from hidden state information H100-Hx. Thus, FIG. 4 shows that different user accounts with the service provider can have different hidden state information for the same RNN model, such as for RNN fraud model 220.

According to a particular embodiment, the first cache 402 and the second cache 404 correspond to cache 112, which may include one or more caches. As such, the first cache 402 may be a separate cache from second cache 404. In other implementations, the first cache 402 and the second cache 404 represent different address spaces within the same cache. It will be appreciated that while FIG. 4 illustrates only two caches, the service provider system 102 can include any number of caches to store hidden state information corresponding to any number of user accounts with the service provider.

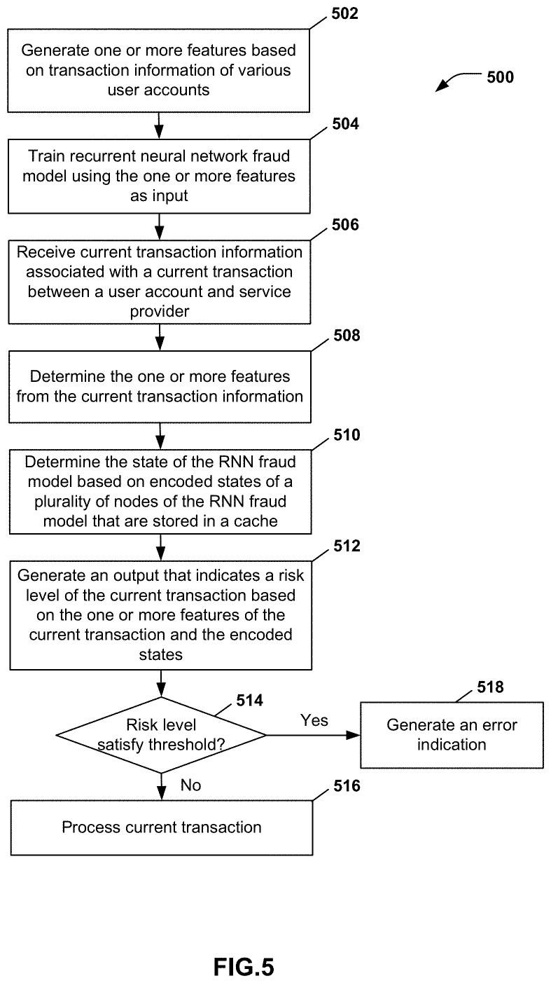

FIG. 5 illustrates an example flow diagram of a method 500 for feature-based recurrent neural networks for fraud detection, according to one or more particular embodiments. The method 500 may be performed by the components of the service provider system 102. The method begins at step 502, where the service provider system generates one or more features based on transaction information of past transactions of various accounts with the service provider. At step 504, the service provider system trains a RNN fraud model using the one or more features.

At step 506, the system provider system 102 receives current transaction information associated with a current transaction between a user account and the service provider. At step 508, the service provider system determines or extracts the one or more features from the current transaction information. At step 510, the service provider system determines the current state of the RNN fraud model based on encoded states of a plurality of nodes that are stored in a cached, such as cache 112. At step 512, the service provider system generates an output that indicates a risk level of the current transaction based on the extracted features and the encoded states.

At step 514, the service provider system determines whether the risk level satisfies a risk threshold. If the risk level does not satisfy the risk threshold, the method 500 proceeds to step 516, where the service provider system processes the current transaction. At step 518, if the risk level satisfies the risk threshold, the service provider system generates an error indication and terminates the current transaction.

### Example Computing Device

Turning now to FIG. 6, a block diagram of one embodiment of computing device (which may also be referred to as a computing system) 610 is depicted. Computing device 610 may be used to implement various portions of this disclosure including any of the components illustrated in FIG. 1 and FIG. 2. Computing device 610 may be any suitable type of device, including, but not limited to, a personal computer system, desktop computer, laptop or notebook computer, mainframe computer system, web server, workstation, or network computer. As shown, computing device 610 includes processing unit 650, storage 612, and input/output (I/O) interface 630 coupled via an interconnect 660 (e.g., a system bus). I/O interface 630 may be coupled to one or more I/O devices 640. Computing device 610 further includes network interface 632, which may be coupled to network 620 for communications with, for example, other computing devices.

In various embodiments, processing unit 650 includes one or more processors. In some embodiments, processing unit 650 includes one or more coprocessor units. In some embodiments, multiple instances of processing unit 650 may be coupled to interconnect 660. Processing unit 650 (or each processor within 650) may contain a cache or other form of on-board memory. In some embodiments, processing unit 650 may be implemented as a general-purpose processing unit, and in other embodiments it may be implemented as a special purpose processing unit (e.g., an ASIC). In general, computing device 610 is not limited to any particular type of processing unit or processor subsystem.

Storage subsystem 612 is usable by processing unit 650 (e.g., to store instructions executable by and data used by processing unit 650). Storage subsystem 612 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 612 may consist solely of volatile memory, in one embodiment. Storage subsystem 612 may store program instructions executable by computing device 610 using processing unit 650, including program instructions executable to cause computing device 610 to implement the various techniques disclosed herein.

I/O interface 630 may represent one or more interfaces and may be any of various types of interfaces configured to couple to and communicate with other devices, according to various embodiments. In one embodiment, I/O interface 630 is a bridge chip from a front-side to one or more back-side buses. I/O interface 630 may be coupled to one or more I/O devices 640 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A system, comprising:
one or more hardware processors; and
a memory storing computer-executable instructions, that in response to execution by the one or more hardware processors, causes the system to perform operations comprising:
receiving a request to process a current payment transaction between a payment provider and a user having a user account with the payment provider;
determining a state of a recurrent neural network (RNN) fraud model for the user account by accessing a cache storing a set of encoded states for a plurality of nodes included in the RNN fraud model, the set of encoded states being previously calculated based on execution of the RNN fraud model with respect to a prior transaction of the user account, wherein the prior transaction is an immediately preceding transaction to the current payment transaction;
executing the RNN fraud model based on data associated with the current payment transaction and the set of encoded states stored in the cache, wherein the executing the RNN fraud model includes encoding a new set of encoded states for the plurality of nodes;
updating the cache to store the new set of encoded states in place of the set of encoded states; and
determining a risk level corresponding to the current payment transaction based on an output of the executing the RNN fraud model.

2. The system of claim 1, wherein the operations further comprise:
training the RNN fraud model based on a set of transaction features that have been previously computed based on transaction information associated with previous transactions of a plurality of other user accounts with the payment provider.

3. The system of claim 2, wherein the set of encoded states are updated in response to each new transaction processed by the RNN fraud model.

4. The system of claim 2, wherein the transaction information comprises at least one of networking information associated with a user device of the user, a user identifier, a transaction identifier, or a geographic location of the user.

5. The system of claim 1, wherein the cache stores only one set of encoded states corresponding to the user account at a time.

6. The system of claim 4, wherein the new set of encoded states are calculated based on the data associated with the current payment transaction and the set of encoded states stored in the cache.

7. The system of claim 1, wherein the RNN fraud model comprises at least one of a long short-term memory RNN or a gated recurrent units RNN.

8. The system of claim 1, wherein the cache stores a second set of encoded states corresponding to a second instance of the RNN fraud model that has been executed with respect to a transaction between the payment provider and a second user having a second user account with the payment provider.

9. The system of claim 1, wherein the data associated with the current payment transaction includes previously generated features extracted from the current payment transaction.

10. A method, comprising:
receiving a request to process a current transaction between a service provider and a user having a user account with the service provider; and
running a recurrent neural network (RNN) fraud model to determine a risk score associated with the current transaction, the RNN fraud model having a plurality of nodes, and the running the RNN fraud model comprising:
inputting current transaction information associated with the current transaction into the RNN fraud model;
retrieving hidden states corresponding to the plurality of nodes from a cache, the hidden states being previously generated based on a previous transaction of the user account that immediately precedes the current transaction;
calculating a risk score based on a combination of the hidden states and the current transaction information; and
generating a plurality of new hidden states and storing the plurality of new hidden states in the cache.

11. The method of claim 10, further comprising:
determining whether to process the current transaction based on the risk score.

12. The method of claim 10, wherein the plurality of new hidden states are generated based on the current transaction information and the hidden states that were previously generated based on the previous transaction.

13. The method of claim 10, further comprising:
prior to the running the RNN fraud model, training the RNN fraud using a plurality of features that were previously generated based on prior transactions of a plurality of other user accounts with the service provider.

14. The method of claim 13, wherein the current transaction information associated with the current transaction includes a features vector corresponding to the plurality of features being extracted from the current transaction.

15. The method of claim 10, wherein the storing the plurality of new hidden states in the cache further comprises replacing the hidden states that were previously generated based on the previous transaction.

16. The method of claim 10, wherein the cache stores respective hidden states for a plurality of other user accounts with the service provider.

17. A non-transitory computer readable medium storing computer-executable instructions that in response to execution by one or more hardware processors, causes a service provider system to perform operations comprising:
receiving a request to process a current transaction between a service provider and a user having a user account with the service provider; and
running a recurrent neural network (RNN) fraud model to determine a risk score associated with the current transaction, the RNN fraud model having a plurality of nodes, and the running the RNN fraud model comprising:
inputting current transaction information associated with the current transaction into the RNN fraud model;
retrieving hidden states corresponding to the plurality of nodes from a cache, the hidden states being previously generated based on a previous transaction of the user account that immediately precedes the current transaction;
calculating a risk score based on a combination of the hidden states and the current transaction information; and
generating a plurality of new hidden states and storing the plurality of new hidden states in the cache.

18. The non-transitory computer readable medium of claim 17, wherein the plurality of new hidden states are generated based on the current transaction information and the hidden states that were previously generated based on the previous transaction.

19. The non-transitory computer readable medium of claim 17, wherein the operations further comprise:
prior to the running the RNN fraud model, training the RNN fraud using a plurality of features that were previously generated based on prior transactions of a plurality of other user accounts with the service provider.

20. The non-transitory computer readable medium of claim 17, wherein the storing the plurality of new hidden states in the cache further comprises replacing the hidden states that were previously generated based on the previous transaction.
